(19) United States
(12) Patent Application Publication
(10) Pub. No.: US 2008/0118900 A1
(43) Pub. Date: May 22, 2008

(54) Pop-Up Toy

(76) Inventor: Anthony A. Salerni, Bedford, NH (US)

Correspondence Address: MESMER & DELEAULT, PLLC, 41 BROOK STREET, MANCHESTER, NH, 03104, US

(21) Appl. No.: 11/942,006

(22) Filed: Nov. 19, 2007

Related U.S. Application Data
(60) Provisional application No. 60/860,099, filed on Nov. 20, 2006.

(51) Int. Cl. G09B 1/02; A63H 33/00; G09B 5/00

(52) U.S. Cl. 434/258; 434/348; 446/487; 446/75

(57) ABSTRACT

A pop-up educational toy for a child includes a housing having a display platform, an actuator mechanism coupled to the housing and operably connected to the display platform, and a display attached to the display platform and having a display area for interchangeably receiving items that have unique personal meaning to the child where the display changes from a non-stimulatory arrangement to a stimulatory arrangement when the actuator mechanism is activated by the child.

This application claims the benefit of U.S. Provisional Patent Application No. 60/860,099, filed Nov. 20, 2007.

### BACKGROUND OF THE INVENTION

1. Field of the Invention

The present invention relates generally to a pop-up educational toy. Particularly, the present invention relates to a pop-up educational toy containing displays for removable items or images.

2. Description of the Prior Art

Pop-up educational toys for children have been in use for years. In general, these devices work by suddenly displaying pictures or items upon actuation of a triggering mechanism by the child operator. Various types of pop-up educational toys have been devised.

U.S. Pat. No. 3,768,175 (1973, Hill et al.) discloses a pop-up learning toy. The pop-up learning toy includes a cube-shaped housing which can be squeezed to release the lid and cause a pop-up member to rise through the top of the housing. A toy set includes numerous pop-up blocks, each having a marking on the outside that represents a question, and each block having a pop-up member which displays a marking that shows the answer to the question.

U.S. Pat. No. 6,494,459 (2002, Polick) discloses a book and pages having a mechanical means for activating a pop-up figure. The pop-up figure is associated with the theme of the book and pops up upon opening the front cover, last page or other page of the book.

U.S. Pat. No. 4,798,555 (1989, Schaub et al.) discloses a toy pop-up figure. The toy pop-up figures includes a rotatable cylinder, a pivotally mounted L-shaped member supporting a figure, and a mechanism coupling the cylinder to the L-shaped member for causing the L-shaped member and figure to pop-up upon rotation of the cylinder in either direction.

U.S. Pat. No. D268,274 (1983, Greenberg) discloses a multiple element pop-up toy design. The design appears to display a vertically sliding display upon activation of a release mechanism associated with that particular element.

U.S. Pat. No. D509,545 (2006, Nash) discloses a pop-up toy similar to a jack-in-the-box with a box in the shape of a baseball with the pop-up figure being a baseball player.

U.S. Pat. No. 4,216,610 (1980, Ferris) discloses a pop-up toy that includes a base having an upstanding first stem with a piston affixed to the end of the stem, a hollow body having a generally cylindrical bore mounted for upward and downward sliding movement on the first stem, a head portion including a second stem having a piston affixed to the lower end thereof, the stem being inserted through an aperture into the hollow body for upward and downward sliding movement. Also included is a flexible air impact bulb and conduit which communicate with the body so as to pressurize the interior of the hollow body to elevate the body upwardly on the stem of the base, which, in turn, elevates the stem of the head portion upwardly of the body when the bulb is compressed by impact.

U.S. Pat. No. 4,237,650 (1980, Goldfarb) discloses a preschool play apparatus. The apparatus includes a base having a wall defining a plurality of different shape holes. There is a translucent viewing window in the wall adjacent each of the holes. There is also a plurality of plugs or inserts having shapes which match the shapes of the holes. The child-user attempts to insert the plugs in the holes of matching shapes. When successful, the inserted plug engages a mechanism which moves a picture up to the adjacent translucent window so that the picture is visible through the window.

U.S. Pat. No. 6,468,126 (2002, Herber) discloses a pop-up device. The base of the device is held in a compressed state by a release mechanism. Upon triggering of the release mechanism, the device is released and pushed through the cake or other confection, thereby providing surprise and entertainment.

The prior art, however, suffer from several disadvantages. The main disadvantage with conventional pop-up educational toys is habituation of the child operator. These devices are only capable of presenting the items or pictures that are fixed to the specific device. It is not possible to change or vary the items presented. Repeated use of the device causes the child operator to become habituated to the stimuli, which ultimately erodes the frequency of its use.

Another disadvantage with conventional pop-up educational toys is that the presented items are only assumed to be pleasing or desirable to the child operator. Typically, the pictures or items that are presented are caricatures of animals or faces. It has been demonstrated that infants and toddlers possess highly sophisticated neural mechanisms for facial recognition and identification. The nature of an infant or toddler's ability to recognize caricatures or how they might interpret them remains unclear.

Still another disadvantage with conventional pop-up educational toys is that the items or pictures that these devices present have no unique personal meaning to the child operator.

Therefore, what is needed is a pop-up educational toy that lessens habituation of the child operator to the toy. What is further needed is a pop-up educational toy that has unique personal meaning to the child operator. What is also needed is a pop-up toy that presents items that are pleasing and/or desirable to the child operator.

### SUMMARY OF THE INVENTION

It is an object of the present invention to provide a pop-up educational toy that lessens habituation of the child operator to the toy. It is another object of the present invention to provide a pop-up educational toy that has unique personal meaning to the child operator. It is a further object of the present invention to provide a pop-up educational toy that presents items that are pleasing and/or desirable to the child operator.

The present invention achieves these and other objectives by providing a pop-up educational toy that allows adult caregivers the means to attach items or pictures to a pop-up educational toy that will have unique personal meanings to the child operator. This will lessen the habituation that normally occurs with the prior art pop-up toys. When habituation finally occurs with the present invention, the adult caregiver may elect to change the items or pictures thereby presenting the child operator with a new set of stimuli that has unique personal meanings to the child operator.

The present invention provides a housing having a display platform, an actuator mechanism coupled to the housing and operably connected to the display platform, and a display attached to the display platform and having a display area for interchangeably receiving items that have unique personal meaning to the child. The display changes from a non-stimulatory arrangement to a stimulatory arrangement when the actuator mechanism is activated by the child. The displayed items may include pictures of family members, family pets, etc. The critical feature of the present invention is the interchangeability of the display items and the customization of the display for the child operator. This prevents the pop-up toy of the present invention from becoming boring for the child operator which would cause the child operator to become less and less interested in the pop-up educational toy.

In one embodiment of the present invention, the pop-up toy is mechanically activated. A housing contains one or more display platforms that mechanically move between a hidden position to an exposed position. Each display platform includes a display with a display area configured to interchangeably receive an item or image that has unique personal meaning to a child operator. The display platform is mechanically connected to an actuator mechanism that is connected to the housing. The actuator mechanism is configured to be engagable by the child operator. If the housing has a plurality of display platforms, the there is an actuator mechanism for each display platform. The actuator mechanism can be mechanical, electrical or electromechanical. The actuator mechanism can further be one of a rocker mechanism, a slide mechanism, a push-button mechanism, a turn dial mechanism, a toggle mechanism, a lever mechanism, and a touch surface mechanism. The movement of the actuator mechanisms causes levers in the housing to move which, in turn, disengages a spring loaded locking mechanism in the platform box which holds its respective display platform in its closed or hidden position. When the locking mechanism is disengaged, the display platform moves into a position that allows the child operator to view the display.

Each display platform may have a biasing member that forces the display platform containing the display into an exposed position when the hidden display platform is release by the child operator when the child activates the actuation mechanism. Alternatively, the display platform may have a biasing member that forces the display platform containing the display into the hidden position and is only in the exposed position when the child activates the actuation mechanism. The length of time the display is exposed in the latter configuration may be only while the child operator engages the actuation mechanism or some other predefined time that regulates the position of the display platform after initial engagement by the child.

In another embodiment of the present invention, the display may be electronic for displaying digital pictures. The housing may optionally include a memory module capable of containing a plurality of digital pictures that possess unique personal meaning to the child operator. The plurality of pictures may optionally be changed by the child caregiver through a user input module or may automatically change after each activation of the display platform by the child operator. Additionally, the present invention may incorporate an electronic module that is pre-programmed or user programmable to regulate the display such as the length of time an image is displayed, how often it changes, the selection of the images, etc., as each display platform is activated by the child operator.

The present invention is preferably configured to be placed on a surface or in the lap of a child operator. The child operator may engage the actuator mechanisms 16 to activate the displays 18 showing to the child operator images or items of unique personal meaning to the child operator. The use of images or items of unique personal meaning to the child operator will lessen the habituation that normally occurs with pop-up toys showing items or images that do not have unique personal meanings to the child operator. With the present invention, if and when habituation occurs, the adult caregiver may elect to change the items or images in the present invention with additional items or images having unique personal meaning to the child operator thereby presenting the child operator with a new set of stimuli.

### BRIEF DESCRIPTION OF THE DRAWINGS

FIG. 1 is a perspective view of the present invention showing a display visible on its display platform.

FIG. 2 is a schematic view of another embodiment of the present invention with electronically controlled digital images and electronic digital displays.

### DETAILED DESCRIPTION OF THE PREFERRED EMBODIMENT

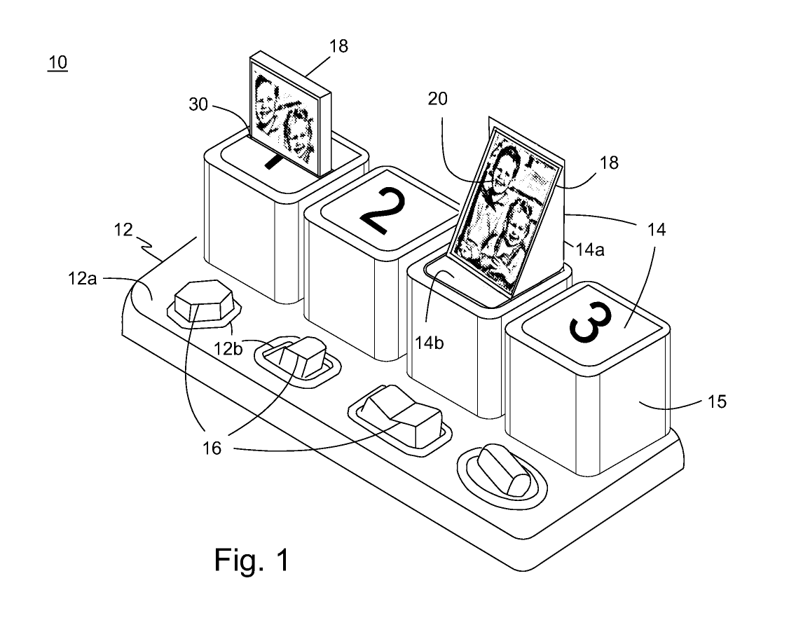

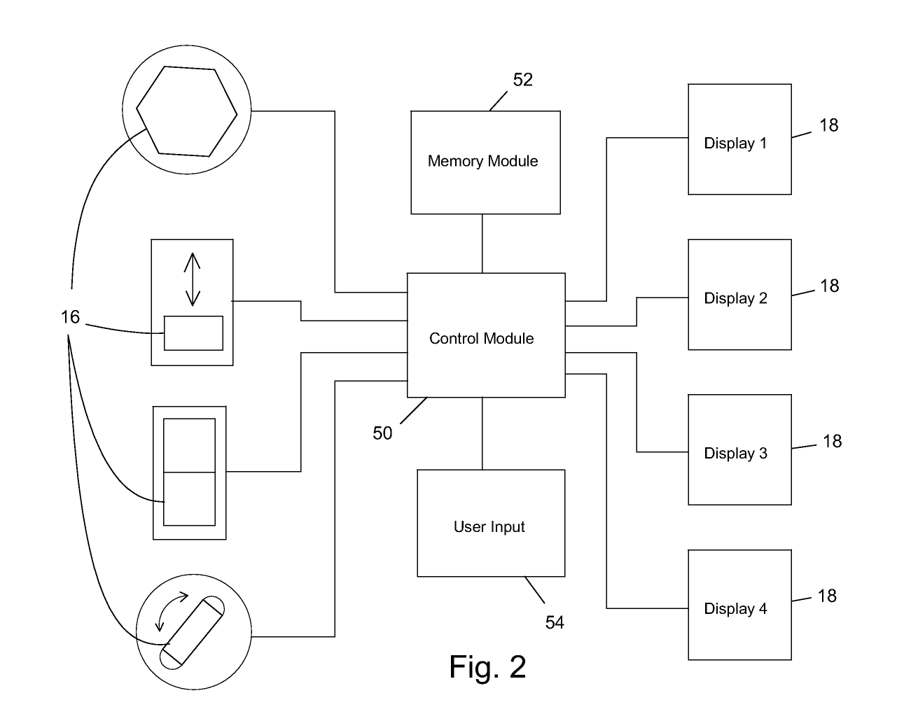

The preferred embodiment(s) of the present invention is illustrated in FIGS. 1-2. FIG. 1 illustrates one embodiment of a pop-up educational toy 10 of the present invention. Pop-up toy 1 0 includes a housing 12, a plurality of display platforms 14, and a plurality of actuator mechanisms 16. Each display platform 14 includes a display 18 having a display area 20. Display area 20 is adapted for easy replacement of a displayed item, which is an item having unique personal meaning to a child operator. The display platform 14 is hidden from sight until an actuator mechanism 16 is engaged.

The primary component that results in a substantial deviation from the prior art is the plurality of display areas 20 which are attached to the plurality of display platforms 14. Each display platform 14 serves as a secure base for the displays 18. The display platform 14 includes horizontal and vertical opaque walls forming a platform box 15. Each platform box 15 holds a display platform 14 and its display 18. In this embodiment, display platform 14 is pivotally mounted near the top of platform box 15. There is an actuator mechanism 16 for each display platform 18. Actuator mechanism 16 may be a rocker mechanism, a slide mechanism, a push-button mechanism, a turn dial mechanism, a toggle mechanism, a lever mechanism, and a touch surface mechanism. It is preferable that actuator mechanism 16 be oversized for ease of use by the child operator. Actuator mechanism 16 may also be electronic in nature.

Housing 12 is preferably an opaque, box-like, hollow structure that contains the activation linkage elements (not shown) between the actuator mechanism 16 and display platform 14. Other embodiments of the present invention do not require that housing 12 be physically attached to platform boxes 15, which contain display platforms 14 and the displays 18. Housing 12 holds and provides an operational surface 12a for actuator mechanisms 16. Each actuator mechanisms 16 protrudes through an opening 12b on the operational surface 12a of housing 12. Housing 12 also provides a presentation surface or stage for platform boxes 15. The connections between actuator mechanisms 16, activation linkage elements (not shown) and display platforms 14 are supported and hidden by housing 12. Platform boxes 15 are secured to housing 12 and the internal spaces of each platform box 15 communicates with the inside of housing 12.

Actuator mechanisms 16 connect to levers through the activation linkage elements that disengage a locking mechanism that keeps the display platforms 14 and their respective displays 18 hidden from view within the platform boxes 15. Each display platform 14 is pivotally mounted to its respective platform box 15. A display 18 is connected to each display platform 14. Actuator mechanism 16 may optionally be electronic in nature and may activate other electronic switches, locks relays, data processors or other electronic devices/circuits of the present invention. Alternatively, the display 18 or any variation thereof, may be connected to the housing by a set of rails or slides that allow the display 18 to emerge from a slot 30 in a display platform 14 when an actuator mechanism 16 is engaged.

Platform box 15 is a hollow opaque cube. Platform boxes of other shapes may also be desirable. While the preferred embodiment of platform box 15 is cubical, no limitations on its possible shapes are implied.

Each display 18 is hidden within housing 12, i.e. in a non-stimulatory arrangement, until activated by the child. Activation occurs when the child engages one of the plurality of actuator mechanisms 16, which in turn causes the display platform 14, which is operably connected to the engaged actuator mechanism 16, to move to an exposed position, i.e. in a stimulatory arrangement. For example, the display item may be an image and, more particularly, a picture that has unique personal meaning to the child.

The display 18 may be similar to any type of picture frame available today. It will have the same or a slightly smaller width than that of the display platform 14. The mechanism and manner by which an image or picture is inserted can optionally be made child proof as well as water resistant. In certain instances, it would be advantageous for the display 18 to be similar to a transparent box where the box has at least one transparent side visible to the child operator. This would also incorporate a child proof opening mechanism. Adult caregivers would be able to place items or pictures into this box-like display. While the preferred embodiment of this box-like display would be cubical, no limitations on its possible shapes are implied.

Display platform 14 has two opaque walls 14a and 14b at right angles to one another. Optional variations of display platform 14 include a slotted opaque surface where the slot 30 is sized to permit the display 18 so that the display frame can rise through it for viewing by the child operator. Another useful variation would be a display platform that includes a trap-like door or doors that open to allow visualization of the display 18.

Another embodiment of the present invention includes an electronic device capable of displaying electronic or digital information. The information could be visual-based or auditory-based or both. The display 18 would typically be electronic displays such as, for example, LED, LCD or plasma panels. FIG. 2 is a schematic illustration of one example of an electronic based pop-up toy 10 of the present invention. A control module 50 contains the central processing circuit that controls the images to be shown on the displays 18 when one of the actuator mechanisms 16 is activated. A memory module 52 may optionally be coupled to control module 50 and stores the images that have unique personal meaning to the child operator. A caregiver/user input module 54 may also be included that provides a user interface for downloading the unique personal images into memory module 52 or for manipulating image sequencing, timing, etc. that occurs during use of the present invention by the child operator. It is noted that the electronic-based pop-up toy 10 may be adapted to use a variety of power sources including line power, batteries and the like, all as is well-known in the art.

When an actuator mechanism 16 is activated, a signal is sent to control module 50, which then activates the appropriate display 18. Control module also retrieves from memory module 52 a pre-selected or a randomly selected image for transmitting to display 18. Control module 50 may also optionally activate any release mechanism to allow display 18 to “pop-up” from display platform 14. It should be understood that control module 50 may include all necessary electronic circuitry including memory and user input or may be a plurality of separate modules or circuits electronically coupled together.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A pop-up educational toy for a child, the toy comprising:
a housing having a display platform;
an actuator mechanism coupled to the housing and operably connected to the display platform; and
a display attached to the display platform and having a display area for interchangeably receiving items that have unique personal meaning to the child wherein the display changes from a non-stimulatory arrangement to a stimulatory arrangement when the actuator mechanism is activated by the child.

2. The toy of claim 1 wherein the housing has a plurality of display platforms and a plurality of actuator mechanisms, each of the plurality of display platforms being operably connected to one of the plurality of actuator mechanisms.

3. The toy of claim 1 wherein the display is selected from the group consisting of an LCD display, an LED display, a plasma display, a non-electronic picture frame, and a box having at least one transparent side visible to the child.

4. The toy of claim 1 wherein the actuator mechanism is selected from the group consisting of mechanical, electrical, and electromechanical triggering devices.

5. The toy of claim 1 wherein the actuator mechanism is selected from the group consisting of a rocker mechanism, a slide mechanism, a push-button mechanism, a turn dial mechanism, a toggle mechanism, a lever mechanism, and a touch surface mechanism.

6. The toy of claim 1 wherein the items are digital images.

7. The toy of claim 1 wherein the display platform is pivotally mounted to the housing and moves between a hidden position to an exposed position.

8. The toy of claim 1 further comprising an electronic image display module electronically coupled to a memory module, a control module, a user input module, and the actuator mechanism.

9. A method of reducing habituation with a pop-up educational toy, the method comprising:
displaying an picture having a unique personal meaning to a child in a picture-changeable display that changes from a non-stimulatory arrangement to a stimulatory arrangement in the pop-up educational toy when an actuator mechanism of the pop-up educational toy is activated by the child; and
changing the picture with another picture having a unique personal meaning to the child when habituation is detected.

10. The method of claim 9 wherein the displaying step further includes displaying the picture in a display area of the display selected from the group consisting of an LCD display, an LED display, a plasma display, a non-electronic picture frame, and a box having at least one transparent side visible to the child.

11. A pop-up educational toy for a child, the toy comprising:
a housing having a plurality of display platforms;
a plurality of actuator mechanisms coupled to the housing wherein each of the plurality of actuator mechanisms is operably connected to one of the plurality of display platforms; and
a display attached to each of the plurality of display platforms, each display having a display area for interchangeably receiving pictures that have unique personal meaning to the child wherein the display area changes from a non-stimulatory arrangement to a stimulatory arrangement when an actuator mechanism connected to a specific display platform of the plurality of display platforms is activated by the child.

12. The toy of claim 11 wherein the plurality of actuator mechanisms is one of a rocker mechanism, a slide mechanism, a push-button mechanism, a turn dial mechanism, a toggle mechanism, a lever mechanism, and a touch mechanism.

13. The toy of claim 11 wherein the display is selected from the group consisting of an LCD display, an LED display, a plasma display, a non-electronic picture frame, and a box having at least one transparent side visible by the child.
